(19) United States
(12) Patent Application Publication
(10) Pub. No.: US 2003/0208957 A1
(43) Pub. Date: Nov. 13, 2003

(54) Portable tree pod structure

(76) Inventor: Robert Meurer, Chippewa Falls, WI (US)

Correspondence Address: MANELLI DENISON & SELTER, 2000 M STREET NW SUITE 700, WASHINGTON, DC, 20036-3307, US

(21) Appl. No.: 10/394,244

(22) Filed: Mar. 24, 2003

Related U.S. Application Data
(60) Provisional application No. 60/378,673, filed on May 9, 2002.

(51) Int. Cl. A01G 23/02

(52) U.S. Cl. 47/73

(57) ABSTRACT

A portable tree pod structure 10 includes a base 12 constructed and arranged to rest on a surface. The base includes forklift-engaging structure 20 constructed and arranged to be engaged by forks of a forklift to move the tree pod structure. A support frame 22 is mounted for rotation with respect to the base. A pod 24 is coupled with the support frame 22 for rotation therewith. The pod is constructed and arranged to receive and carry a root ball of a tree.

This application is based on U.S. Provisional Application No. 60/378,673, filed on May 9, 2002, and claims the benefit thereof for priority purposes.

### FIELD OF THE INVENTION

This invention relates transporting trees and, more specifically, to individual, portable tree pod structures that permit transportation of several trees from a nursery to a planting site in a single trip.

### BACKGROUND OF THE INVENTION

When large trees must be moved from a nursery to a planting site, presently, landscaping contractors can transport only one tree at a time from the nursery to the site since they must use a tree spade attached to a skid steer loader for transporting as well as for digging and planting the tree. This process is very slow and increases the cost to the contractor and consumer.

There are presently trailers that have tree pods fixed thereto. However, the trailer can only be used to transport trees to a general area near the planting site, since the tree pods are not removable from the trailer and thus are unable to be moved to the exact planting location within the tree pod.

Accordingly, there is a need to provide a tree pod structure that can be moved on a trailer of a vehicle and yet be removable from the trailer so as to be moved to a tree planting location.

### SUMMARY OF THE INVENTION

An object of the invention is to fulfill the need referred to above. In accordance with the principles of the present invention, this objective is obtained by providing a portable tree pod structure that includes a base constructed and arranged to rest on a surface. The base includes forklift-engaging structure constructed and arranged to be engaged by forks of a forklift so as to move the tree pod structure. A support frame is mounted for rotation with respect to the base. A pod is coupled with the support frame for rotation therewith. The pod is constructed and arranged to receive and carry a root ball of a tree.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

FIG. 1 is a perspective view of a tree pod structure provided in accordance with the principles of the present invention and shown in an upright position.

FIG. 2 is a perspective view of the tree pod structure of FIG. 1 shown in a tilted position.

### DETAILED DESCRIPTION OF THE PREFERRED EXEMPLARY EMBODIMENT

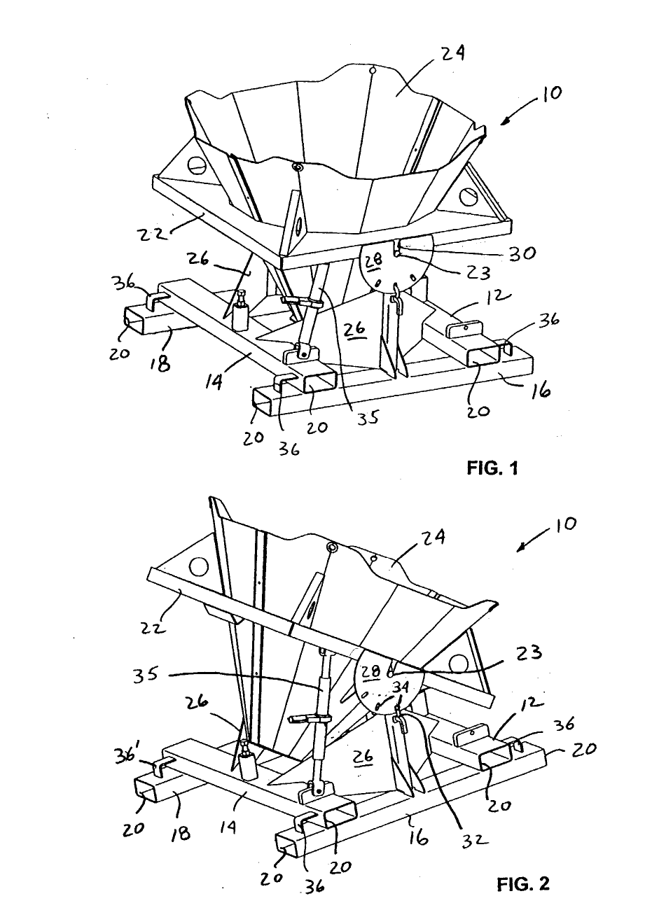

With reference to FIGS. 1 and 2, a portable tree pod structure, generally indicated at 10, is shown in accordance with the principles of the present invention. The tree pod structure 10 includes a generally rectangular base including a first pair of members 12 and 14 in spaced relation defining first and second sides of the base. A second pair of members 16 and 18 disposed in spaced relation are joined to the first pair of members to define third and fourth sides of the base. Thus, the first pair of members is disposed generally transversely with respect to the second pair of members. The bottom members 16 and 18 of the base have generally planar surfaces to as to rest on a surface such as a trailer of a vehicle, as will be explained below. Each of the first and second pair of members defines forklift-engaging structure such that the base can be access and moved from each side thereof. In the embodiment, the members 12, 14, 16 and 18 are hollow members and the forklift engaging structure is defined by the as an openings 20 at the ends of members 12, 14, 16 and 18. The openings 20 are sized and spaced to receive forks of a forklift.

A support frame 22 is mounted for rotation with respect to the base via pivot 23. A generally cone-shaped pod 24 is coupled with the support frame 22 for rotation therewith. The pod 24 is constructed and arranged to receive and carry a root ball of a tree, as will be explained more fully below. In the embodiment, the pod 24 is made of heavy-duty metal so as to keep the root ball intact. Vertically extending supports 26 are fixed to the base to space the support frame 22 from the base to permit room for rotation of the support frame 22 and pod 24. The supports 26 can be considered to be part of the base.

The support frame 22 has a pivot-receiving member 28 coupled to a side thereof that rotates with the support frame 22. The pivot-receiving member 28 includes a cutout 30 that receives the pivot 23. The vertically extending supports 26 include the pivot 23 and at least one support 26 includes a spring-loaded locking structure 32. The locking structure 32 engages a lock receiving structure in the form of an index opening 34 in the pivot-receiving member 28. In the embodiment, there are three index openings 34 so that the support frame 22 and thus pod 24 can be locked into three different positions. As shown in FIG. 1, the frame 22 and pod 24 can be locked in an upright or vertical position for loading and unloading a tree carried thereby. In addition, to transport the tree so as to not contact power lines during transporting thereof, the frame 22 and pod 24 can be locked in a right tilted position (FIG. 2) or in a left tilted position (not shown). The tilting can be performed manually or if desired, hydraulics or other actuators can be employed to perform the tilting. In the embodiment, a conventional ratchet jack 35 is coupled between the support frame 22 and the base to cause rotation of the support frame 22 and thus pod 24 between the vertical and tilted positions.

It can be appreciated that the support frame 22 can include the pivot 23 while a vertically extending support 26 can include the pivot receiving structure 28 without departing from the principles of the invention.

The tree pod structure 10 is constructed and arranged to be carried on a trailer of a vehicle. Thus, in the embodiment, the base includes tie-down structures 36 at each corner area thereof so that the tree pod structure and be tied down with chain or rope to the trailer and be transported. The tie down structures are generally L-shaped elements welded to sides of members 12 and 14 and to the tops of members 16 and 18, with each tie down structure 36 defining a channel having opened ends through which a chain or rope may extend. For example, with reference to FIG. 2, since tie down structures 36 and 36′ are aligned, a single chain can extend through the tie down structures 36 and 36′, with ends of the chain being fixed to the trailer. Another chain can be used to tie down the other side of the base. Since the tree pod structure 10 is not permanently fixed to the trailer, advantageously, removal of the rope or chain permits the tree pod structure 10 to be removed from the trailer with a forklift and moved to the exact planting location.

Contractors can dig out the tree that needs to be transplanted and load it into the tree pod structure 10 for easy transporting. The tree pod structure 10 is configured to be loaded easily onto a truck bed or trailer and be removably secured thereto. By using the tree pod structures, contractors can transport multiple trees thus saving time and money. Alternatively, a nursery can place the trees in the tree pod structures and a contractor can load the tree pod structures on truck bed or trailer, deliver the tree pod structures and thus the trees therein to a site and then return the tree pod structures to the nursery.

If many trees are to be used at a site, the tree pod structures can be removed from the trailer or truck and moved to the various locations around the site so that they can be planted later. Since the tree pod structures are removable from the truck bed or trailer, the trailer can be used for other purposes when the tree pod structures are removed.

Advantages of the invention include:

Smooth tilting action with self-locking mechanism allows for single person operation

Sturdy base designed for easy loading onto a truck bed or trailer with a forklift

Tilting pod so taller trees do not interfere with power lines during transportation

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A portable tree pod structure comprising:
a base constructed and arranged to rest on a surface, the base including forklift engaging structure constructed and arranged to be engaged by forks of a forklift so as to move the tree pod structure,
a support frame mounted for rotation with respect to the base, and
a pod coupled with the support frame for rotation therewith, the pod being constructed and arranged to receive and carry a root ball of a tree.

2. The tree pod structure of claim 1, wherein a vertically extending support is coupled with the base, wherein one of the vertically extending support and support frame includes a pivot and the other of the vertically extending support and support frame includes a pivot-receiving member associated with the pivot so as to permit rotation of the support frame with respect to the pivot.

3. The tree pod structure of claim 2, wherein the vertically extending support includes the pivot and the support frame includes the pivot-receiving member.

4. The tree pod structure of claim 3, wherein the vertically extending support includes locking structure and the pivot-receiving member includes lock-receiving structure such that the support frame and thus pod can be locked in an upright position and in at least one tilted position with respect to the base.

5. The tree pod structure of claim 4, wherein the lock-receiving structure includes a plurality of openings in the pivot-receiving member and the locking structure is constructed and arranged to selectively engage one of the openings.

6. The tree pod structure of claim 1, further including an actuator coupled between the base and support frame and being construed and arranged to assist in causing rotation of the support frame.

7. The tree pod structure of claim 6, wherein the actuator is a ratchet jack.

8. The tree pod structure of claim 1, wherein the base includes tie-down structure constructed and arranged to permit the base to be tied down with respect to a surface.

9. A portable tree pod structure comprising:
a base constructed and arranged to rest on a surface, the base including a first pair of members in spaced relation defining first and second sides of the base, and a second pair of members in spaced relation and joined to the first pair of members to define third and fourth sides of the base, each of the first and second pair of members defining fork-lift engaging structure for receiving forks of a forklift such that the base can be moved from any of the sides thereof,
a support frame mounted for rotation with respect to the base,
a pod coupled with the support frame for rotation therewith, the pod being constructed and arranged to receive and carry a root ball of a tree, and
an actuator coupled between the support frame and base and constructed and arranged to assist in rotating the support frame.

10. The tree pod structure of claim 9, wherein the actuator is a ratchet jack.

11. The tree pod structure of claim 9, wherein the first pair of members is disposed generally transversely with respect to the second pair of members.

12. The tree pod structure of claim 11, wherein each of the members of the first and second pairs of members is hollow with openings at ends thereof sized and spaced to receive forks of a forklift.

13. The tree pod structure of claim 9, wherein a vertically extending support is coupled with the base, wherein one of the vertically extending support and support frame includes a pivot and the other of the vertically extending support and support frame includes a pivot-receiving member associated with the pivot so as to permit rotation of the support frame with respect to the pivot.

14. The tree pod structure of claim 13, wherein the vertically extending support includes the pivot and the support frame includes the pivot-receiving member.

15. The tree pod structure of claim 14, wherein the vertically extending support includes a locking structure and the pivot-receiving member includes lock-receiving structure such that the support frame and thus pod can be locked in an upright position and in at least one tilted position with respect to the base.

16. The tree pod structure of claim 15, wherein the lock-receiving structure includes a plurality of openings in the pivot-receiving member and the locking structure is constructed and arranged to selectively engage one of the openings.

17. The tree pod structure of claim 9, wherein the base includes tie-down structure constructed and arranged to permit the base to be tied down with respect to a surface.

18. The tree pod structure of claim 17, wherein the base has for corner areas and the tie down structure defines, at each corner area, a channel having opened ends constructed and arranged to receive a chain or rope there-through.
